(19) United States
(12) Patent Application Publication
(10) Pub. No.: US 2005/0050453 A1
(43) Pub. Date: Mar. 3, 2005

(54) System, method and computer program product for the immediate creation and management of websites and multimedia audiovisuals for CD-ROM ready-to-use and already perfectly operating

(76) Inventor: Telemaco Barnabei, Milano (IT)

Correspondence Address: TELEMACO BARNABEI, VIA PANFILO CASTALDI 41, MILANO, 20124, IT

(21) Appl. No.: 10/651,004

(22) Filed: Aug. 29, 2003

(51) Int. Cl. G06F 15/00

(52) U.S. Cl. 715/513

(57) ABSTRACT

System, method and computer program product are provided for the immediate creation and management of websites and multimedia audiovisuals for CD-ROM ready-to-use and already perfectly operating. This computer program is the extremely easy-to-use software wich enables every person who knows how to surf the web and to write an e-mail, to create at once professional level websites and multimedia audiovisuals, avoiding all technical problems related to the programming, the graphical layout, the connections, interactivity . . . etc. Apply the original software functions of this computer program with “Just One Click”: to create a search engine inside the website, to add already connected new pages, to create fading images slide-show presentations, to get the download of any file, to insert more videos on a single web page, to update or add data, to publish on the Internet, to create multimedia audiovisual for CD-ROM.

### CROSS-REFERENCE TO RELATED APPLICATIONS

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION The present invention relates generally to the field of web pages and, more particularly, to method and system for the immediate creation and management of unlimited websites, web portals and multimedia audiovisuals for CD-ROM ready-to-use and already perfectly operating.

The personal computer that appeared at the end of the 70's (Apple 1977, IBM 1979), by the mid 80's had already become the main vehicle of the methodological revolution involving all human production and cultural activities thanks to the rapid evolution of software and electronics technologies. Internet, in the meantime, took off within the U.S. university context in 1984 and the World Wide Web in 1993 to become the world's most diffused integrated digital communication method. People first learnt how to use the PC and later, by surfing on the Internet and using innovative audiovisuals on CD-ROM, how to use the latest and most complete communication means so far available: Multimedia Information on Demand. From young people to adults, millions of users, by surfing the web, have acquired the ability to “read” Information on Demand, remaining however passive on-lookers. In fact, after having learnt how to “read” the web, surfers have felt the need to also know how to “write” the web: that is they felt the need to have their own website. In recent times the demand for domains has grown enormously, beyond all bounds.

The attempts on the part of many Internet service providers to let their customers build their own website on-line haven't been successful, yielding only impractical, unappealing and limited web page editor softwares residing in the providers' portals. After having with difficulty built, On-Line, a few web pages, those customers find themselves with a double problem:
1—being snobbed by the by now sophisticated web surfers and being labelled as “sad B-class website” and even their inserted contents of the sites have lost credibility.
2—they've got nothing left when they give up their subscription to that service.
   Hence, today, positive visibility on the web still incurs not only great expense but also submission to the hegemony of the webmasters, the new “scribes” of the Third Millennium, who write and communicate on behalf of others. Today, throughout the world, webmasters can be considered as the “priests” of the Internet; they only detain the power to transfer the whole “Active” presence of mankind onto the web. What's more, after the creation of the website, people depend entirely on the webmasters for each and every—inevitable and natural—modification. The dependency on the webmasters is no doubt suffocating, endless and costly. Often, the sad alternative for their customers to this submission is to discontinue the updating, to “park” the website and to no longer use it for business purposes. (which increasingly happens in the case of small and medium sized companies).

These are the reasons why I have felt the need to invent and produce this computer program product with the ambitious mission of enabling every person that
knows how to surf the web and to write an e-mail, to create at once professional level websites and multimedia audiovisuals for CD-ROM, avoiding all technical problems related to the programming, the graphical lay-out, the connections, interactivity . . . etc.

A computer program without competition, unique on the world's marketplace. It's very user-friendly, and enables all web surfers to attain to a professional result that only the best—and more expensive—web companies can nowadays achieve. With this computer program the user only has to take care of the insertion and the modification of personal data, in the easiest possible way, with just one click: to participate autonomously and in first person to the web. While using a PC, people got used to manage directly their personal data. They cannot continue to transfer to others their own expression and interactive multimedia communication: that would be an unthinkable step backwards. Hence this computer program wants to give all peoples around the world the ability to communicate freely both on the Internet as on CD-ROM and pave the way for an unbounded and global diffusion of their ideas, products and activities.

### BRIEF SUMMARY OF THE INVENTION

In summary, the present invention is an extremely easy-to-use computer program that can create and manage an unlimited amount of different professional websites, portals and multimedia audiovisuals for CD-ROM, with an unlimited amount of interconnected pages ready-to-use and already perfectly operating. Enables every person who knows how to surf the web and to write an e-mail, to create at once professional level websites and multimedia audiovisuals for CD-ROM, avoiding all technical problems related to the programming, the graphical lay-out, the connections, interactivity . . . etc. It's the ultimate tool for companies and professionals, students and all net-surfers and guarantees an effective and highly visible presence on the web, without the—so far, compulsory and continuous—dependence on webmasters.

this computer program uses the most innovative and sophisticated technologies available today on the Internet, guaranteeing a professional result that only the best web companies were able to provide.

Today's users want websites and multimedia audiovisuals on CD:

with top-level appearance, but spending the least possible
with the most technologically advanced functions without wasting time
having continuous personal control on the insertion and updating of data
   this computer program satisfies all these needs: the very easy to use computer program—with an extremely simple interface—implementing however the most sophisticated and complex technology both on the web as in multimedia on CD-ROM. Hence, the implementation of the “Just One Click” technology: the minimum controls possible to start automated and complex functions.

### BRIEF DESCRIPTION OF THE SEVERAL VIEWS OF THE DRAWING

FIG. 1A shows the home page of the “READY-SITE Catalog” displayed on the display screen by the computer program.

FIG. 1B shows one of the “READY-SITE Catalog” pages.

FIG. 2A shows the “Create New Project from READY-SITE” form displayed on the display screen by the computer program.

FIG. 2B shows the new website created renaming the “READY-SITE” choosen.

FIG. 3A shows the “Rename Page” form displayed on the display screen by the computer program.

FIG. 3B shows the renamed web page.

FIG. 4A shows the “Add Page” button of the “Pages” menu on the interface of the computer program.

FIG. 4B shows the new web page automatically added.

FIG. 5A shows the “Publish on the Internet” form displayed on the display screen by the computer program.

FIG. 5B shows the “Publish on the Internet” form ready for the automatic publication on the Internet of the website.

### DETAILED DESCRIPTION OF THE INVENTION

To clarify the principle of absolute uniqueness of the software I have invented, it must be stated first of all that no software existing on the world market today is conceptually comparable to this computer program. The reason is that in the most important web-editor software available on the market all create and manage single web pages, (i.e. Microsoft FrontPage, Micromedia Dreamweaver, Adobe Golive, etc.) the web pages are created and managed individually and isolated. Such software programs, therefore, are not capable to control, and thus manage, a website as a whole. On the contrary, this invented computer program displays the processing website (derived by a “READY-SITE” selected by the user or created directly using the function “New Project”) structured as a unique and complete entity but permanently open to continuous extensions and modifications.

Using this computer program, with 3 easy Steps—in just a few minutes!—you can be simultaneously on the INTERNET and CD.

First Step>Choose, from the appropriate Catalog, one of the innovative

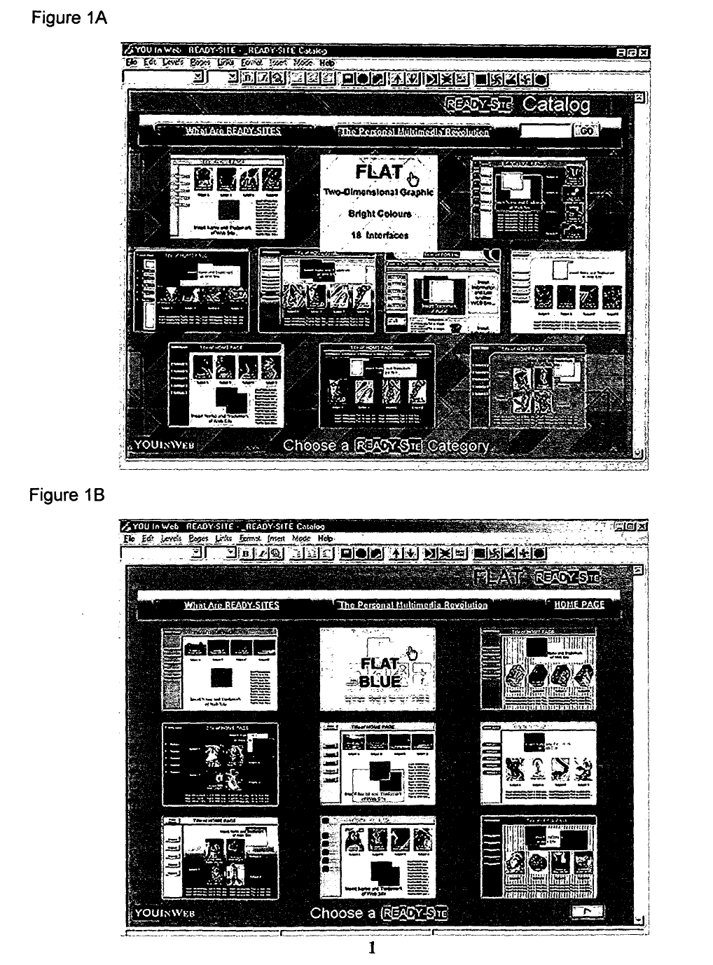

“READY-SITES”: innumerable websites and Portals—ready-to-use—realised in two or three dimensional multicolour graphics, with an unlimited amount of interconnected pages, moving along only with animated buttons. Referring now to FIG. 1A, the home page of the “READY-SITE Catalog” displayed on the display screen by the computer program and FIG. 1B, one of the “READY-SITE Catalog” pages during the user's choice.

Second Step>After you've chosen a customised “READY-SITE” and given it a name, you insert with—Just One Click—all Your Data (text, pictures, spoken information, drawings, music, videos, etc.) using the exclusive software functions: images slide-show on a single webpage, an internal search engine, the adding of unlimited already linked new pages, automatically composed e-mails, etc.

Third Step>Publish on the Internet, with—Just one Click—the newly created website. Simultaneously, if you wish, with—Just 1 Click!—you can realize the folder “Multimedia” to create immediately a complete CD-ROM.

Apply the computer program Plus with “Just One Click”: the minimum controls possible to start Automated and Complex Functions.
Just One Click to create a Search Engine inside the Website
Just One Click to add already Connected New Pages
Just One Click to create Fading Images Slide-Show Presentations
Just One Click to get the Download of any File
Just One Click to create automatically pre-set E-Mails
Just One Click to listing your newly created Website in major Search Engines
Just One Click to insert More Videos on a Single Web-page
Just One Click to insert Music and Spoken Information
Just One Click to update or add Data
Just One Click to publish on the Internet
Just One Click to create Multimedia for CD-ROM.

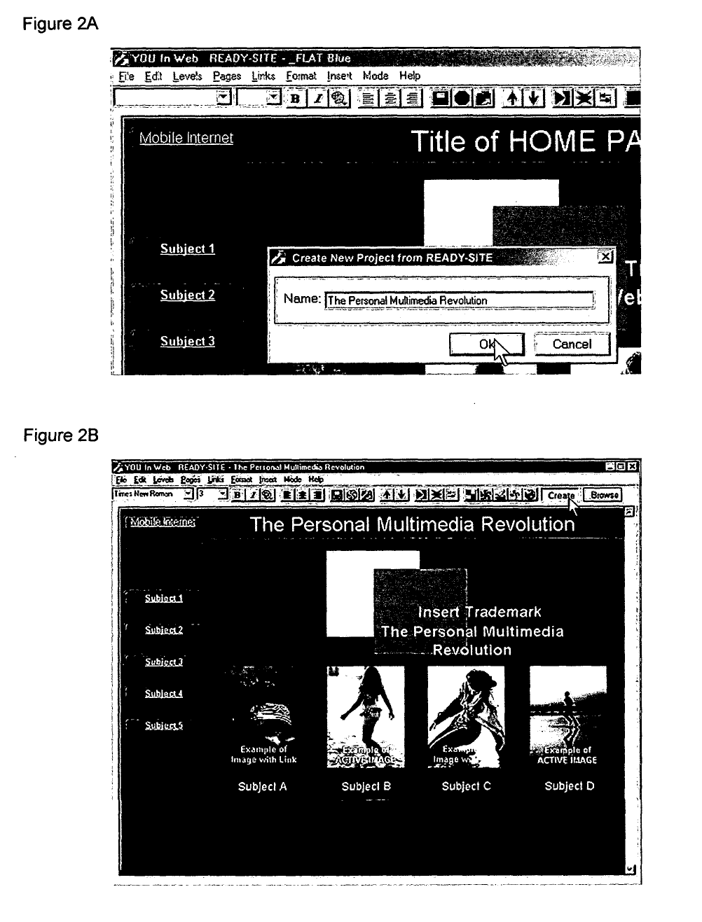

The uCreate New Project from READY-SITE” software function: within each “READY-SITE” there are some key-words, common to any “READY-SITE”, allowing their substitution in order to obtain the transformation of the “READY-SITE” selected into a customized project of website/multimedia audiovisual with a name chosen by the user. Consequently, with one single user's click on the respective push-button located on the software interface, the “READY-SITE” selected is copied and re-named without transforming in any way the original “READY-SITE”, so that it will be possible to use it subsequently “n” number of times. The new project created of website/multimedia audiovisual, already perfectly operating, is now ready for any subsequent customised modification (i.e. re-naming the pages and automatic adding of new pages) as well as for inserting/updating the user's data. The transformation between the “READY-SITE” selected and the project copied from it mainly occurs activating the following function: a motor has been integrated within the software that browses through each webpage of the current project, selecting along any path the references relating to the “READY-SITE” selected and substituting them with the name the user has given to the newly created project. Referring now to FIG. 2A, the “Create New Project from READY-SITE” form displayed on the display screen by the computer program and FIG. 2B, the new website ready-to-use created renaming the “READY-SITE” choosen.

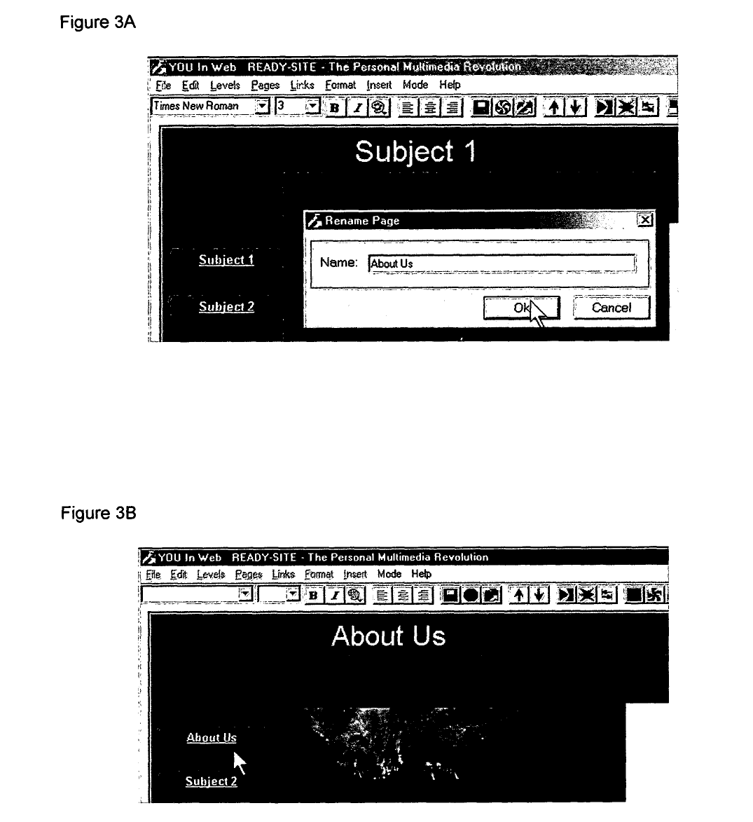

The “Rename Page” software function: this function allows the automatic re-naming of the standard pages existing in any “READY-SITE” with the new name selected by the user.
By activating this function, with one single user's click on the respective push-button located on the software interface, the computer program browses through each page within the current project and substitutes any reference to the page that is being re-named with the name given by the user to the new page. In this way, the name and the link of all active push-buttons existing in the project concerning the old name of the page are automatically substituted by the software with the new name (for instance: from “Subject 1” to “About Us”.) Both the heading of the renamed web page as all buttons “Subject 1” on all pages, will automatically be renamed in “About Us”. Each web page can be renamed at all times. Referring now to FIG. 3A, the “Rename Page” form displayed on the display screen by the computer program and FIG. 3B, the renamed web page.

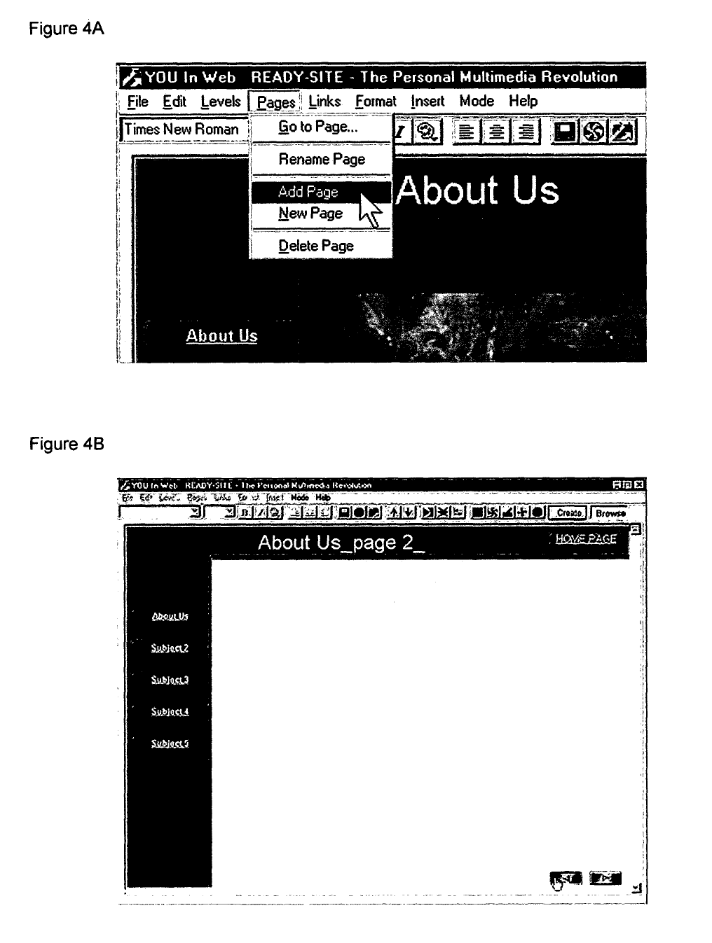

The “Add Page” software function: starting from any page, this function allows, with one single user's click on the respective push-button located on the computer program interface, to automatically add an unlimited number of subsequent web pages. The web pages being added are automatically created by the program with push-buttons linking each added web page to the preceding one. While creating any added web page, the computer program proposes the selection of an interface model. Should the user not have created other interface models, the software uses a “standard Interface” model existing within any “READY-SITE”, identical to the interface of all other web pages of the project of website/multimedia audiovisual. While creating any added web page, the web page name inserted by the computer program is the name of the initial web page followed by a progressive number. The user may rename any added web page and the link of the connecting push-buttons will be automatically updated within the whole project. The user may delete any added web page and the link of the connecting push-buttons will be automatically updated within the whole project. Referring now to FIG. 4A, the “Add Page” button of the “Pages” menu on the interface of the computer program and FIG. 4B, the new web page automatically added with push-buttons linking each added web page to the preceding one.

The computer program provides for the management of all data inserted within the web page (text, images, videos, etc), positioning them exactly “by pixel” as well as with regard to their three-dimensional overlapping. The computer program divides into two web pages (one web page for the editing and one web page for the publication) each web page existing within the processing website/multimedia audiovisual, mainly for managing the following software functions:
A—for managing the precision movement “by pixel” of any object inserted on the web page (text, images, videos, etc).
B—for overlapping any object inserted on the web page (text, images, videos, etc).
C—for managing the paths of any object inserted on the web page: “absolute” paths on the editing web page, that are substituted by “relative” paths on the publication web page.
   The editing web page updates the publication page anytime it is saved or the push-button “Browse” is activated or the user leaves the current web page in order to enter into another one.

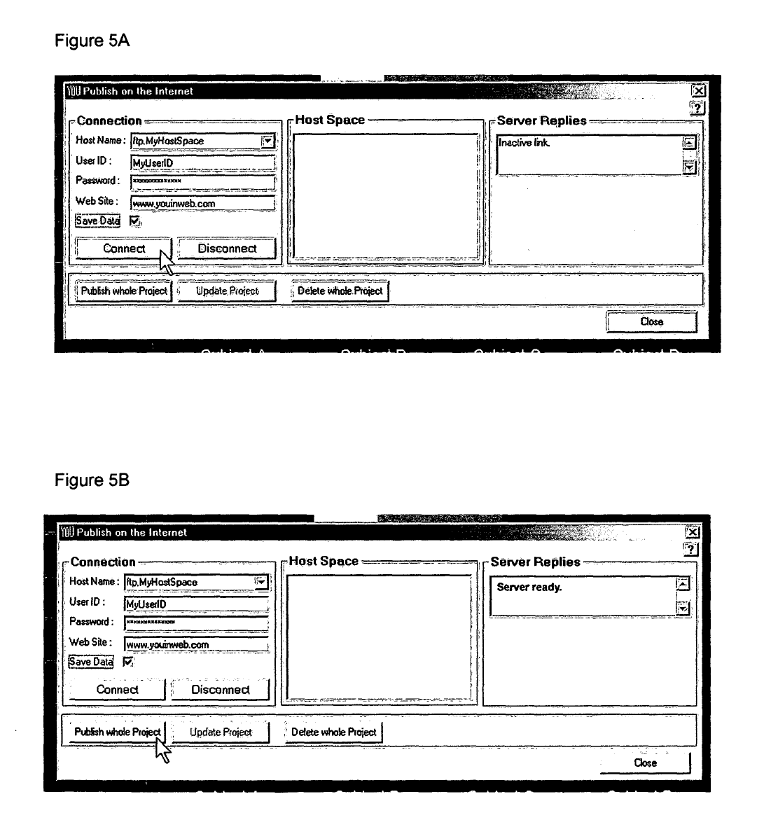

The “Publish on the Internet” software function: by clicking on this function, the computer program will transform and store in a special temporary directory any file existing within the processing website/multimedia audiovisual (the web pages and all user's data) required for the publication. The publication form allows the automatic direct connection with the remote server in Internet and immediately after the authentication has been done, on a display appears the various response messages sent by the server and the list of all files and directories currently existing within the host. The publication form will thus offer the possibility to publish within the remote server, not only at first level but also at subsequent ones. With one single user's click on the push-buttons “Publish whole Project” or “update Project” located on the publication form, the computer program will automatically publish or update the website. During the publication, the publication form displays the insertion of all the files and folders of the website into the remote server. Referring now to FIG. 5A, the “Publish on the Internet” form displayed on the display screen by the computer program and FIG. 5B, the “Publish on the Internet” form with the computer program ready for the automatic publication on the Internet of the website.

The “Create Multimedia (for CD-ROM) of the current Project” software function: this function of the invented computer program allows the immediate transformation of any project into a multimedia audiovisual software for CD-ROM, capable of being installed on any other PC in which the invented computer program has never been installed. With one single user's click on the push-button “Create Multimedia (for CD-ROM) of the current Project” located on the software's interface, the computer program will automatically create a folder, including a customized installer software with the name and data of the Multimedia Audiovisual, that will allow the installation of the Multimedia Audiovisual on any other PC in which the invented computer program has never been installed. The user will only have to masterize the content of the created folder on a new CD support. The introduction of the CD-ROM created on any other PC in which the invented computer program has never been installed, will cause the automatic start (in autorun) of a customized installation form with the following procedures:
the customized installation of the multimedia audiovisual software;
the installation of the components (i.e. all data) into the 2 different functional modes: from Hard Disk Drive or from CD-ROM.
   At the end of the components' installation, a customized icon will appear on the PC desktop. A double click on the customized icon will cause the start of the Multimedia Audiovisual just installed.

The “Internal Search Engine” software function: with one single user's click on the push-button “Insert Internal Search Engine” located on the software's interface, the computer program will automatically create an internal search engine of any word of the text inserted in all the web pages of the whole website. The originality of this internal search engine, specifically invented for use within the computer program, is based on the peculiarity that when asked to search for a word existing in any web page of the website, it does not make any call to the remote server on-line but it is directly managed by the browser of the client. This gives an absolute operative autonomy of the internal search engine, allowing thus the user never to bother about various compatibility problems with the different remote server types where he will publish on the Internet his website. At the same time, for the same reasons of absolute operative autonomy, this solution also allows the perfect utilization of this internal search engine even when a Multimedia Audiovisual for CD-ROM is created.

If a user prefers to insert other self-made graphical features onto the website, with this computer program this is very easy too. Just select “New Project” and starting form a blank page, the user can insert them (Interface and Active Buttons) with—Just 1 CLICK—as you like and finally click on “Save Interface Model” in the “File” menu. Then click on “New Page” (in the “Page” menu) and repeat the insertion as many times as you need. The new website is then ready for the insertion of all data and to go onto the web and on CD.

Market Situation: today, there's not one single software on the mondial market comparable to this computer program. The softwares web-page editor available today (Microsoft FrontPage, Macromedia DreamWeaver, Adobe GoLive, etc.) are dedicated to the exclusive use of webmasters, webdesigners and web professionals, hence a totally different range of market and final-users. These programs are also void of interactive graphics (that have to be made elsewhere) as well as of all main exclusive software functions such as: automatic or interactive Images Slide-Show on a single webpage, an internal Search Engine, the adding of already linked New Pages, automatically composed E-Mails, etc. There are no programs that can automatically produce these works that consequently have to be carried out manually by webmasters, by paying an extra fee. In addition, this computer program is the only existing software able to simultaneously create with—Just One Click—Multimedia Audiovisuals for CD-ROM for professional goals (like, for example, more videos in a single page), ready to be installed with—Just One Click—on any PC that has never installed my computer program before.

This computer program is available in two versions: “READY-SITE”>the Standard version for the retail market B-to-C (Business to Consumer) offered at a price that takes account of the “Innovatory Value” of the product, while being at the same time accessible to a very large users' group (school and university Students, C.V.s of Employees and Professionals, Families, etc.) so as to create a widespread knowledge and usage of “The Personal Multimedia Revolution”. This version of the software contain the complete catalogue of the “READY-SITES” and all the above listed functions for the insertion of all the User's Data and the prompt publication on the web; “READY-SITE PRO”>the Professional version, for the B-to-B (Business to Business) distribution, targeting “S.O.H.O.” (Small Office/Home Office) and “S.M.B.” (Small Medium Business) markets: i.e. small medium Companies, Distributors and Dealers, Associations, Free-Lancers, Service Companies, Research and other Institutes, school and university Tuition, etc.

The difference with the Standard version lies in the higher number of functions and different “READY-SITES” (more Portals), but above all in the addition of 2 important functions:
Just 1 CLICK to create a Search Engine inside the Website
Just 1 CLICK to create Multimedia for CD-ROM
   Today this computer program is unique in the world, as it creates these 2 functions automatically, without the assistance of expensive webmasters and specialized professionals.

Technical Specifications;

This computer program requires: Personal Computer with Pentium 166 MMX processor or superior, Microsoft Internet Explorer 5.5 or Microsoft Internet Explorer 6.0.

Compatibility with Operating Systems: Microsoft XP, Windows ME, 2000, 98 Second Edition.

The computer program is currently available in the following versions: English language, Spanish language, German language and in Italian language. The computer program has been predisposed to function with all the above listed versions of Microsoft Windows, translated into all languages. (for example, the computer program English version works on Windows ME in Dutch language). Therefore, if for particular localisation needs the computer program and all “READY-SITES” were to be translated, this would only entail the literal translation as the part of Information Theory compatibility has already been completely resolved.

1. A method for the immediate creation and management of websites and multimedia audiovisuals for CD-ROM ready-to-use and already perfectly operating, comprising the steps of:
automatic re-naming of the website or multimedia audiovisual with the name given by the user.
automatic re-naming of the standard pages existing in the website or multimedia audiovisual with the name given by the user.

2. A method according to claim 1 further comprising the step of automatically add of an unlimited number of subsequent web pages, created by the computer program with push-buttons, linking each added webpage to the preceding one.

3. A method according to claim 1 further comprising the step of creation of two web pages for each web page existing within the website, one web page for the editing and one web page for the publication, necessary for managing the precision movement of any object within the page, for overlapping any object within the page and for managing the paths of any object within the page.

4. A method according to claim 1 further comprising the step of automatic creation of fading unlimited images Slide-Show Presentation on a single web page.

5. A method according to claim 1 further comprising the step of automatic creation of internal search engine into the website or multimedia audiovisual with the peculiarity that when asked to search for a word existing in any web page of the website, it does not make any call to the remote server on-line but it is directly managed by the browser of the client, giving an absolute operative autonomy, that allows the perfect utilization of the internal search engine even when a multimedia audiovisual for CD-ROM is created.

6. A method according to claim 1 further comprising the step of automatic publication or update of the website, with the automatic direct connection with the remote server in Internet, possibility to publish within the remote server not only at first level but also at subsequent ones, display of the various response messages sent by the server and the list of all files and directories currently existing within the host.

7. A method according to claim 1 further comprising the step of automatic creation of multimedia audiovisuals for CD-ROM, including a customized installer software with the name and data of the multimedia audiovisual, that will allow the installation of the multimedia audiovisual on any other personal computer.
